(19) United States
(12) Patent Application Publication
(10) Pub. No.: US 2026/0309158 A1
(43) Pub. Date: Oct. 8, 2026

(54) Method for Detecting Cavitation and/or a Bubbling-in or Inflow of Air within a Hydraulic System

(71) Applicant: KSB SE & Co. KGaA, Frankenthal (DE)

(72) Inventors: Christoph DROPMANN, Frankenthal (DE); Tobias WEBER, Frankenthal (DE)

(21) Appl. No.: 19/481,379

(22) PCT Filed: May 3, 2024
(86) PCT No.: PCT/EP2024/062220

§ 371 Date: Nov. 4, 2025

(30) Foreign Application Priority Data
May 5, 2023 (DE) 10 2023 111 782.3

(51) Int. Cl. F04D 15/00; F15B 19/00

(52) U.S. Cl. CPC F04D 15/0088; F15B 19/00

(57) ABSTRACT

A method for detecting cavitation or a bubbling-in or inflow of air within a hydraulic system. The hydraulic system includes at least one electric motor-driven pump for conveying a liquid pumped medium. The method includes capturing at least one operating parameter of the drive motor which influences the torque of the drive motor. The method also includes determining the variance of the operating parameter thus captured over a defined observation period. The method also includes detecting cavitation and/or of a bubbling-in or inflow of air in the hydraulic system, in the event that the variance value thus determined exceeds a defined threshold value.

### CROSS REFERENCE TO RELATED APPLICATION

This application is a 371 National Stage Application of PCT/EP2024/062220, filed May 3, 2024, which claims priority from German Patent Application No 10 2023 111 782.3 1, filed May 5, 2023, the entire disclosure of which is herein expressly incorporated by reference.

### BACKGROUND

The disclosure relates to a method for detecting cavitation and/or a bubbling-in or inflow of air within a hydraulic system comprising at least one electric motor-driven pump for conveying a liquid pumped medium within the hydraulic system.

State-of-the-art pumps are increasingly equipped with comprehensive functions for monitoring the current pump operating mode, together with extensive functions for monitoring the entire hydraulic system. It is thus intended that potential anomalies in the pump or within the hydraulic system should be identified as efficiently and as rapidly as possible, in order to enable the generation of alarm messages or the implementation of countermeasures, where applicable.

One potential anomaly, for example, is the occurrence of cavitation, which can occur in the region of the pump impeller of centrifugal pumps. Cavitation involves the formation and break-up of vapor-filled voids in the pumped medium, which can result in high-frequency impacts on the pump impeller. The continuous presence of cavitation can result in mechanical damage to the pump, particularly to the impeller, such that the prompt detection of such a phenomenon is desirable in order to enable the execution of remedial measures. The bubbling-in or inflow of air into the hydraulic system can also result in impacts on the impeller and mechanical damage.

### SUMMARY

A predominant contributory factor to the occurrence of cavitation in hydraulic systems, particularly in closed hydraulic systems, is a loss of pressure on the pump intake manifold. In this context, by reference to the detection of cavitation, a concept is also provided for the inference of a low pressure condition in the intake region of the pump, which inference ultimately enables the further detection of a leak within the closed system.

An object of the present disclosure is to enable the reliable and effective detection of the above-mentioned anomalies by means of a novel method.

This and other objects are fulfilled by a method according to the features of the disclosure. Advantageous embodiments of the method are also the subject matter of the disclosure.

According to the disclosure it is proposed that, during the operation of the pump, continuously or cyclically, an appropriate operating parameter of the electric motor-driven pump is captured within the hydraulic system. The operating parameter to be captured is an operating parameter which either characterizes the torque of the pump drive, or which at least assumes a substantial influence or a substantial dependence upon the torque setting of the pump drive.

For the operating parameter thus captured, over a defined observation period, a potential variance of the operating parameter is then ascertained. In other words, by the determination of variance, the degree of a potential signal fluctuation or signal noise in the operating parameter thus captured is ascertained. The variance value ascertained is employed as an indicator of the occurrence of cavitation in the pump and/or of bubbling-in/inflows of air into the hydraulic system. As the high-frequency impacts associated with cavitation resulting from low pressure or the bubbling-in of air generate variances in the resulting torque, and thus an amplified and identifiable signal fluctuation, a rise in the variance value in excess of a definable threshold value can be interpreted as indicative of the presence of cavitation or of bubbling-in/inflows of air.

The duration of the observation period for determining the variance value can lie within the range of 1-10 minutes, preferably between 1-5 minutes, and particularly preferably between 1-2 minutes.

One exemplary operating parameter, the variance value of which is determined, can be the torque itself. The measurement or calculation of an electrical variable of the drive motor which is characteristic of the resulting motor torque is also conceivable. By way of an operating parameter, for example, the take-up of electric motor power and/or the motor current is thus conceivable, in particular a current component associated with the formation of the motor torque such as, for example, the quadratic component i_{q} of the stator current.

The operating parameter is captured over a definable time interval, and the variance of the operating parameter determined by means of statistical methods. By reconciliation with a definable threshold value or reference value, it can be evaluated whether the calculated variance lies within a customary range of values or otherwise deviates therefrom, i.e. the scatter of the operating parameter has otherwise increased. An increase in scatter is indicative of an anomaly in pump operation, which anomaly, in particular, can be caused by cavitation and/or by a bubbling-in of air/inflow of air in a closed circuit. The respective operating parameter can either be measured directly or inferred from other variables, and evaluated by means of a motor model on the basis of measured variables.

As an alternative to the above-mentioned operating parameters, the actual pump speed might also be captured and evaluated. The actual speed can be measured by means of a speed sensor or, alternatively, evaluated by means of a motor model. In the case of a pump controller having a speed regulation function, cavitation or a bubbling-in of air/inflow of air can be triggers for speed fluctuations such that, by capturing the motor speed and, in particular, by determining the speed variance, a detection of cavitation is enabled.

The occurrence and the degree of cavitation can be influenced by external circumstances. In this context, the employment of a dynamic threshold value, which is adapted to external circumstances, is appropriate for the reconciliation of variance. In this context, the general employment of an adaptive threshold value, which is dependent upon the present operating mode and/or upon the present pump working point, is proposed. In particular, the adaptive threshold value can be dependent upon the present system pressure in the hydraulic installation and/or upon the present pump speed in force and/or upon the present actual temperature of the pumped medium. The temperature of the medium has a substantial influence upon the generation of cavitation on the grounds that, as the temperature of the pumped medium increases, the probability of the occurrence of cavitation also rises.

It is particularly advantageous that, in tandem with the determination of variance, the mean value of the operating parameter, or the mean value of a variable which is derived from the operating parameter, is also determined. In this case, a sliding mean value calculation which, in consequence, determines the mean value over a continuously sliding time window, is preferred. The electric power take-up of the motor is inferred, for example, from the operating parameter, in particular from the motor current, and the actual speed of the motor. By the observation of the mean value, in particular of the power take-up, any drop in pump capacity can be detected which, for example, might be characteristic of a potential pressure loss in the installation which is associated with a leak within the system. However, as a drop in capacity can also be triggered by a routine load variation, by the combined monitoring of the mean value and of the variance value, a distinction can reliably be drawn between a drop in capacity which is triggered exclusively by a load variation, and a drop in capacity which is generated by leaks.

A drop in capacity is thus detected, for example, if the mean value undergoes a variation, in particular an abrupt variation, by a specific differential value.

Consequently, in the event that the system detects a drop in capacity, and an increased variance in the operating parameter captured occurs at the same time, a pressure loss associated with the occurrence of cavitation can be inferred, which pressure loss represents a dependable indicator of the occurrence of potential leaks in the hydraulic system.

In order to prevent any erroneous appraisals, and for the confirmation of a leak, it can be appropriate for an adjusted short-term target speed to be set on the pump motor controller, in order to temporarily operate the motor at the upper limiting current, provided that, in routine operation, the motor has yet to be operated at the upper limiting current. As a result, the accuracy and reliability of the capture of the variance value can be further optimized. Thus, at the temporarily adjusted speed, a further capture of the operating parameter is executed, and the variance determined. In the event that, in this operating state, an increased scatter of the operating parameter and an overshoot of the threshold value again occurs, a routine load variation can thus be ruled out, and a leak in the system confirmed.

For example, the target speed on the speed regulator of the motor controller can be adjusted or increased for operation at the limiting current over a specific time interval, in particular for a period of 1-5 minutes, in particular for a period of 1-4 minutes, and preferably for a period of approximately 3 minutes.

As described above, the hydraulic system is preferably a closed system.

In addition to the method according to the disclosure, the present disclosure further relates to a pump, preferably a centrifugal pump, and particularly preferably a heating circulation pump, for example for a solar heating system, having a pump controller or pump regulator, which pump is configured for executing the method according to the disclosure. The pump controller or pump regulator can be a frequency converter. The same advantages and properties apply to the pump as those described above with respect to the method according to the disclosure. For this reason, any repeated description can be omitted. The pump controller or pump monitoring system can be an integral component of the pump but, alternatively, can also be configured as an external module.

Finally, the disclosure relates to a hydraulic system comprising at least one pump for circulating a pumped medium in a closed cycle, and a pump controller or pump monitoring system which is configured for executing the method according to the method. The pump controller or pump monitoring system can be an integral component of the pump but, alternatively, can also be configured as an external module which is only communicatively connected to an integral pump controller, and which retrieves the requisite operating parameters for the purposes of evaluation from the pump controller.

Further advantages and properties of the method are described in greater detail hereinafter with reference to the embodiments represented in the figures. In the figures:

### BRIEF DESCRIPTION OF THE DRAWINGS

FIG. 1 is a simplified representation of the hydraulic system according to the disclosure;

FIG. 2 is a flow diagram of the method according to the disclosure for leak detection; and

FIG. 3 is an exemplary representation of a timing diagram for the current component i_{q} of the pump drive stator current thus captured.

### DETAILED DESCRIPTION

The disclosure is based upon the finding to the effect that cavitation and/or bubbling-in/inflows of air generate high-frequency and substantial impacts on the impeller of a pump, which impacts, in turn, can result in substantial signal fluctuations in current measurement and in the down-circuit speed control of the pump. According to the disclosure, these signal fluctuations can be detected by means of a novel logic function in the motor controller, by means of which cavitation can be reliably detected.

Moreover, in this manner, a leak or a drop in the system pressure of the hydraulic system, particularly in the event of high medium temperatures, can be reliably detected in closed hydraulic systems.

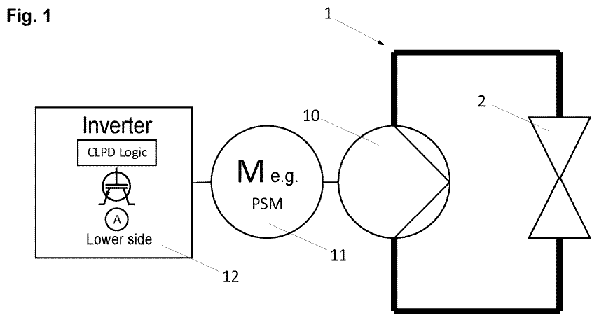

FIG. 1 shows a schematic representation of the potential layout of a hydraulic system of this type. A closed hydraulic circuit 1 is represented, for example a standard heating circuit for heating a residential building. Potential loads within the heating circuit are represented in a simplified manner by reference number 2, and the installed circulating pump is identified by reference number 10. For driving the pump 10, which is configured as a centrifugal pump, an electric motor 11 is employed, particularly a synchronous motor, and particularly preferably a permanent magnet motor, which motor is actuated in an energy-efficient manner by means of the frequency converter 12 and by means of the speed control function which is implemented in the controller of the frequency converter.

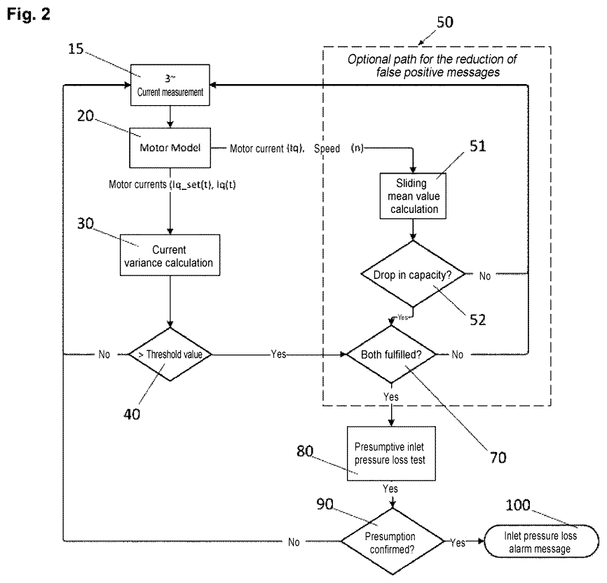

A flow diagram illustrating process steps for leak detection in closed circuits is represented in FIG. 2. Although the entire process is implemented in the pump controller or in the integral frequency converter 12 of the pump 2, in principle, the method might also be implemented externally to the pump, and the requisite operating parameter(s) otherwise communicated by the pump 2 to an external unit for executing the method.

In block 15 of the diagram according to FIG. 2, firstly, determination of the operating parameter is executed wherein, in this case, the motor current take-up of the motor 11 is determined by means of a three-phase current measurement in the frequency converter of the motor controller. By means of the motor model 20 which is saved in a microprocessor, on the basis of the result of measurement, the quadratic component i_{q}(t) of the stator current, which is causally associated with the motor torque, can be calculated. The current component i_{q}(t) is made available to block 30 for the calculation of variance, together with the target value i_{q_set}(t) of the integral current controller.

Scatter around the target value i_{q_set}(t) can then be calculated in block 30 by means of statistical methods. As an observation period for the current component i_{q}(t), a time interval of 1 to 2 minutes is customarily employed. The calculated variance is then compared with an adaptatively adjustable threshold value in block 40 wherein, in the event of a threshold overshoot, the occurrence of cavitation or of a bubbling-in/inflow of air is assumed, and the method then proceeds to block 70 or 80. If the threshold value is not overshot, no anomaly is assumed, and pump operation continues as normal with continuous current measurement in block 15.

In the event that, by means of the method, in addition to cavitation effects, it is also intended to detect a low pressure scenario or a leak in the closed circuit, in tandem with the determination of variance, a requisite detection function 50 for a drop in capacity is appropriate. To this end, the present electric power take-up of the pump motor 11 is determined, and the mean value is calculated over a limited time window (block 51). To this end, block 51 also receives from the motor model 20, additionally to the present motor current i_{q}. The estimated speed n of the motor for calculating the electric power take-up. The time window is sliding, such that an ongoing updating of the power value proceeds. In block 52, an investigation is then executed as to whether an excessively high variation in the mean value, in particular a drop in power take-up, has occurred about a specific minimum value. If such a power drop is in force and, at the same time, the variance calculated in block 30 exceeds the threshold value, in the present case, an inlet pressure loss and an associated occurrence of cavitation or a bubbling-in/inflow of air in the intake region of the pump 10 is assumed. For the purposes of confirmation, a presumptive inlet pressure loss test is executed in block 80.

If a drop in capacity is otherwise detected, but the calculated variance value does not exceed the threshold value, it is assumed that the drop in capacity is exclusively attributable to a routine load variation, and that no leak-related pressure loss is in force. The method then returns to the current measurement in block 15.

The presumptive test executed in block 80 is employed for the confirmation of cavitation or of a potential leak. For the presumptive test, for a short period, for example of the order of 3-5 minutes, the target speed in the speed controller of the pump 10 is temporarily set such that the motor is operated at the limiting current. By means of this measure, signal fluctuations associated with a bubbling-in/inflow or air or with cavitation are further amplified, and can thus be captured in a more accurate and reliable manner. The higher the current intensity, the greater the resulting current variances, thus enabling the confirmation of detection.

In the event that, in this presumptive inlet pressure loss test 80, a further overshoot of the variance threshold value occurs, the presumption of cavitation and the occurrence of a leak in the system can be confirmed, and a corresponding alarm message 100 generated. In principle, it is assumed that variance will undergo a further increase during operation at the limiting current.

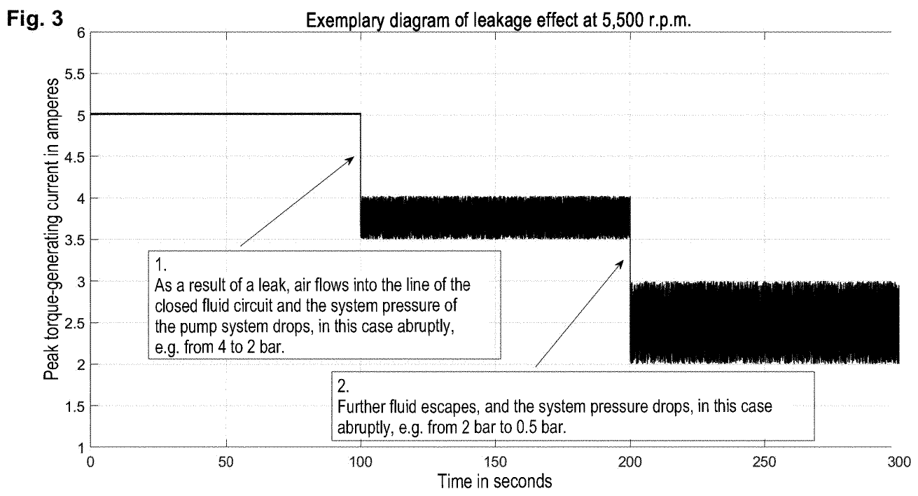

FIG. 3 shows the temporal characteristic of the current component i_{q}(t) which is responsible for the formation of torque. In the time interval from 0 -100 seconds, the current intensity of the component i_{q}(t) is 5 A, wherein the signal characteristic shows minor fluctuations in measurement. At 100 seconds, a massive drop in capacity occurs, and the mean current intensity declines abruptly to approximately 3.75 A, which decline is associated with a pressure drop in the system from 4 bar to 2 bar. In consequence, visibly stronger signal fluctuations in the current component also occur and, potentially, the calculated current variance exceeds a stipulated threshold value such that, in this case, a leak in the system can be inferred which not only dictates the drop in capacity, but which simultaneously results in cavitation and the corresponding current signal fluctuations.

At 200 seconds, a further drop in capacity occurs, dictated by a decline in the system pressure from 2 bar to 0.5 bar. Here again, the outcome is a significant rise in the magnitude of current variances.

By means of the method described herein, a potential system leak in closed hydraulic systems can be reliably inferred, which inference is confirmed by reference to a drop in capacity of the pump motor, and by reference to the occurrence of excessive current signal fluctuations.

As operating parameters for the monitoring logic function are captured in any event in the majority of control modules for pump drives, retrofitting of the method is enabled with no additional hardware and with no comprehensive reconfiguration of the pump controller, such that protection can be retrofitted to existing pump systems in a cost-effective manner.

1.-15. (canceled)

16. A method for detecting cavitation and/or a bubbling-in or inflow of air within a hydraulic system having a pump configured to convey a liquid pumped medium, comprising:
capturing at least one operating parameter of a drive motor of the pump which influences the torque of the drive motor;
determining the variance of the operating parameter thus captured over a defined observation period; and
detecting cavitation and/or of a bubbling-in or inflow of air in the hydraulic system, in the event that the variance value thus determined exceeds a defined threshold value.

17. The method as claimed in claim 16, wherein the operating parameter is the motor torque and/or the electric power take-up of the motor and/or the motor current, and the current component is associated with the formation of the motor torque.

18. The method as claimed in claim 16, wherein the operating parameter is the actual speed of the pump or of the drive motor, or an estimated actual speed of the pump.

19. The method as claimed in claim 16, wherein the defined threshold value for comparison with the variance thus determined is selected according to the operating mode and/or the working point, according to current system pressure and/or the speed of the pump and/or the temperature of the pumped medium.

20. The method as claimed in claim 16, wherein, in tandem with the determination of variance, the mean value of the operating parameter or the mean value of a variable which is derived from the operating parameter is determined.

21. The method as claimed in claim 20, wherein the mean value is formed over a defined time interval or over a sliding time window.

22. The method as claimed in claim 20, wherein, by reference to the mean value, a drop in capacity of the pump is detected, when the mean value undergoes a variation by a specific differential value.

23. The method as claimed in claim 16, wherein a leak in the system is detected in an event that a drop in capacity and cavitation and/or a bubbling-in or inflow of air has been identified, in an event that the variance value exceeds the threshold value and a mean value assumes a variation by a differential value.

24. The method as claimed in claim 16, wherein, in an event of an overshoot of the defined threshold value and/or in the event of a detected drop in capacity, the drive motor is actuated for operation at the limiting current, by the adjustment or increase of the target speed of a speed regulator of the motor controller, and wherein operation at the limiting current is executed over a time interval of 1 to 5 minutes.

25. The method as claimed in claim 24, wherein, during the operation of the pump at the limiting current, the variance value is determined again, in order to confirm an inlet pressure loss of the pump or a low pressure in the intake region of the pump.

26. The method as claimed in claim 25, wherein, during operation at the limiting current, the variance value thus determined is compared with a previously determined variance value and, an inlet pressure loss is confirmed in the event that the variance value ascertained during operation at the limiting current is greater.

27. The method as claimed in claim 16, wherein the stipulated time interval for determining the variance value lies within the range of 1 to 10 minutes, or within the range of 1 to 5 minutes, or within the range of 1 to 2 minutes.

28. The method as claimed in claim 16, wherein the hydraulic system is a closed system.

29. A centrifugal, heating circulation pump, having a pump controller/regulator which is configured to execute the method as claimed in claim 16.

30. A hydraulic system comprising at least one pump configured to circulate a pumped medium in a closed circuit, and a pump controller/monitoring system which is configured to execute the method as claimed in claim 16.
